(19) United States
(12) Patent Application Publication
(10) Pub. No.: US 2009/0007002 A1
(43) Pub. Date: Jan. 1, 2009

(54) CONTENT DISPLAY APPARATUS AND METHOD

(75) Inventors: Shinsuke Masuda, Ome-shi (JP); Takashi Sato, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/163,111

(22) Filed: Jun. 27, 2008

(30) Foreign Application Priority Data
Jun. 29, 2007 (JP) 2007-173324

(51) Int. Cl. G06F 3/048

(52) U.S. Cl. 715/777

(57) ABSTRACT

According to one embodiment, a content display apparatus includes a display device having a tab display area which displays tabs and a content display area which displays content. The content display apparatus also includes a set of direction keys adapted to indicate a plurality of directions. Content corresponding to one of the tabs is displayed in the content display area. The content displayed in the content display area or a display form of the tab display area is changed in accordance with a direction which the set of direction keys indicates.

### CROSS-REFERENCE TO RELATED APPLICATIONS

This application is based upon and claims the benefit of priority from Japanese Patent Application No. 2007-173324, filed Jun. 29, 2007, the entire contents of which are incorporated herein by reference.

### BACKGROUND

1. Field

One embodiment of the invention relates to a content display apparatus and a content display method adapted to display a plurality of kinds of content in one window.

2. Description of the Related Art

As a technique to browse broadcasting content using a tab function, a browser program for browsing markup language documents is described in WO 2004/084056. With this browser program, windows are superimposed on a display area provided on a display device. Also, tabs, which correspond respectively to the windows, are provided on the display area. When a tab is operated, a window corresponding to the operated tab comes to be displayed in front. The tabs are operated using as many color buttons provided on an operating unit as the windows. The windows have colors corresponding to the buttons.

According to a broadcasting receiver disclosed in Jpn. Pat. Appln. KOKAI Publication No. 2006-94410, pages of an electronic program guide can be changed by operating page-changing keys mounted on a remote controller. With the broadcasting receiver, a schedule of programs displayed on the page of the electronic program guide is advanced or brought back temporally in accordance with a direction indicated by an operated page-changing key. Moreover, a page displaying channels are changed in accordance with the direction indicated by the operated key.

According to the browser program of WO 2004/084056, in order to change a window to be displayed in front from a window corresponding to a selected tab to a window corresponding to a left or right tab of the selected tab, a button which corresponds to the desired tab should be operated. A user cannot intuitively instruct the direction of the display change since the buttons do not directly indicate directions but indicate colors. In addition, the number of windows which the display area can display is limited to the same number as the color buttons mounted on the operating unit.

With the above broadcasting receiver disclosed in Jpn. Pat. Appln. KOKAI Publication No. 2006-94410, the page of the electronic program guide can be changed in accordance with a direction indicated by the page-changing key; therefore, a user can intuitively instruct a direction of display change. However, displaying tabs by a tab browser or the like and shifting a selected tab right to left or vice versa is not disclosed.

### BRIEF DESCRIPTION OF THE SEVERAL VIEWS OF THE DRAWING

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an electronic configuration of a broadcast receiving apparatus according to an embodiment of a content display apparatus of the invention;

FIG. 2 is an exemplary external view of a remote controller;

FIGS. 3A, 3B and 3C are exemplary views showing display examples of a display device according to a first embodiment;

FIG. 4 is an exemplary flowchart of a display change process according to the first embodiment;

FIGS. 5A, 5B and 5C are exemplary views showing display examples of the display device according to a second embodiment;

FIG. 6 is an exemplary flowchart of a display change process according to the second embodiment;

FIGS. 7A, 7B and 7C are exemplary views showing display examples of the display device according to a third embodiment;

FIG. 8 is an exemplary flowchart of a display change process according to the third embodiment;

FIGS. 9A, 9B and 9C are exemplary views showing display examples of the display device according to a fourth embodiment; and

FIG. 10 is an exemplary flowchart of a display change process according to the fourth embodiment.

### DETAILED DESCRIPTION

Various embodiments according to the invention will be described hereinafter with reference to the accompanying drawings. In general, according to one embodiment of the invention, a content display apparatus comprises a display unit including a tab display area configured to display tabs and a content display area configured to display content, a content display controller configured to control the content display area of the display unit to display content corresponding to one tab of the tabs, a direction indicator configured to indicate one of directions, a display changer configured to change the content displayed in the content display area in accordance with a direction indicated by the direction indicator, and a tab display controller configured to change a display form of the tab display area in accordance with the direction indicated by the direction indicator.

Embodiments of a content display apparatus according to the present invention will be described hereinafter with reference to the accompanying drawings.

### First Embodiment

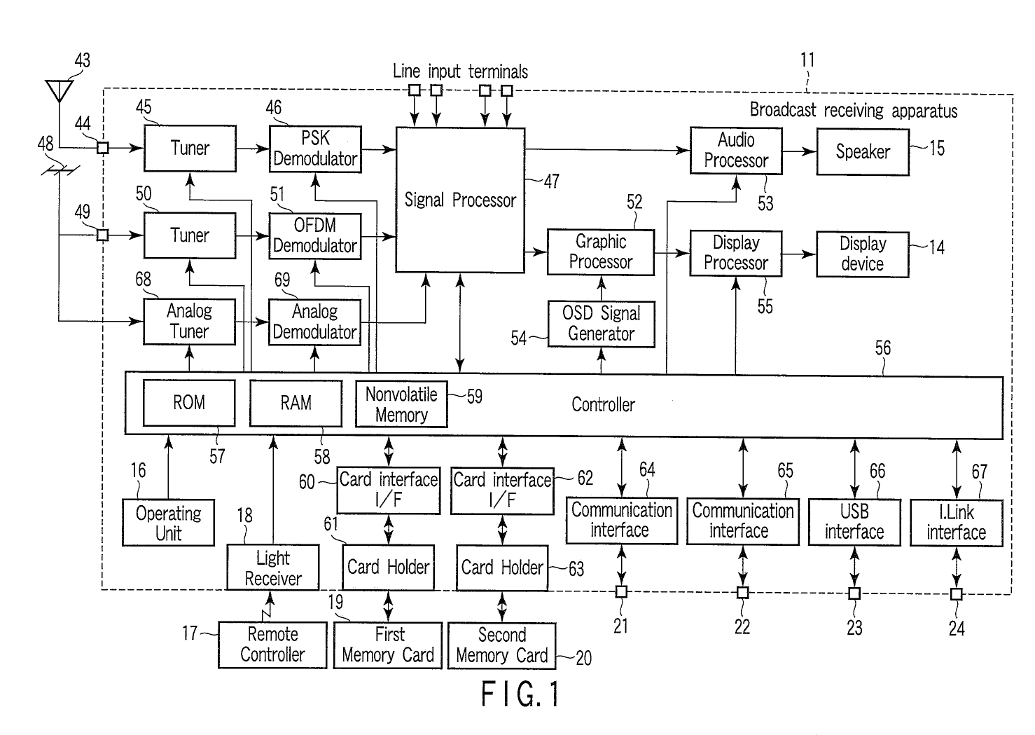

FIG. 1 is an exemplary block diagram showing an electronic configuration of a broadcast receiving apparatus 11 according to an embodiment of a content display apparatus.

The broadcast receiving apparatus 11 includes a controller 56 which controls operations of components in the broadcast receiving apparatus 11. The controller 56 includes a central processing unit (CPU). The controller 56 starts a system control program or various processing programs stored previously in a ROM 57 in response to an operation signal input from an operating unit 16 or an operation signal transmitted from a remote controller 17 and received through a light receiver 18. The controller 56 controls the operations in accordance with the started program, using a random access memory (RAM) 58 as a work memory. Setting information and control information for controlling the operations are stored in a nonvolatile memory 59.

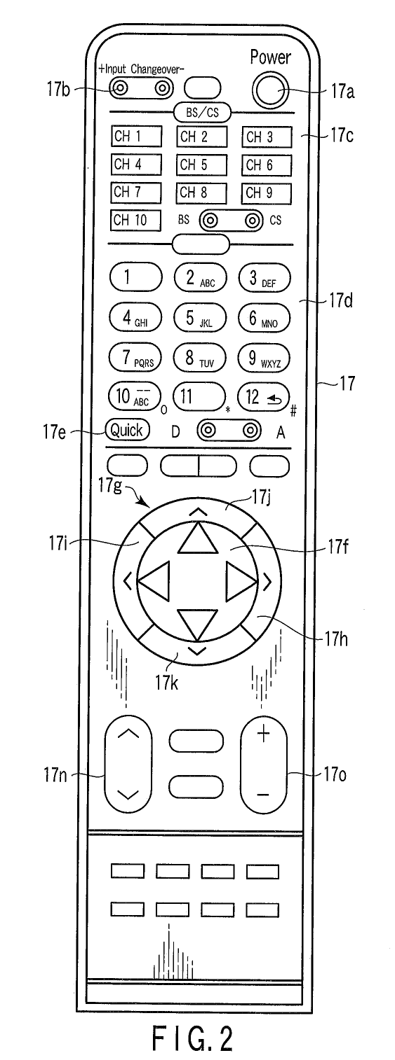

FIG. 2 is an exemplary external view of a remote controller 17. The remote controller 17 includes a power key 17a, an input changeover key 17b, direct channel selection keys 17c for satellite digital broadcasting, direct channel selection keys 17d for terrestrial broadcasting, a quick key 17e, a first direction key 17f, second direction keys 17g, a channel up/down key 17n, a volume adjustment key 17o, etc. The second direction keys 17g are arranged in a ring form around and concentrically with the first direction key 17f which is in a round shape. The first direction key 17f can indicate four directions of up, down, right and left and used for scrolling the displayed content up, down, right or left. The second direction keys 17g includes a RIGHT key 17h, a LEFT key 17i, an UP key 17j, and a DOWN key 17k. In this embodiment, the second direction keys 17g are used for tab selection or to change display form of tabs. The RIGHT key 17h is marked with a symbol, such as an arrow pointing the right direction, which enables a user to intuitively recognize the right direction. Likewise, the LEFT key 17i, the UP key 17j and the DOWN key 17k are respectively marked with symbols which enable the user to intuitively recognize corresponding directions.

An antenna 43 for broadcasting satellite (BS) and commercial satellite (CS) digital broadcasting receives a satellite digital television broadcast signal. The received digital signal is supplied to a tuner 45 through an input terminal 44. The tuner 45 selects a desired digital broadcast signal and then sends the signal to a phase shift keying (PSK) demodulator 46. The PSK demodulator 46 demodulates the digital broadcast signal and then outputs the demodulated digital broadcast signal to a signal processor 47.

An antenna 48 for terrestrial digital broadcasting receives a terrestrial digital television signal. The received digital signal is supplied to a tuner 50 through an input terminal 49. The tuner 50 selects a desired digital broadcast signal and then sends the signal to an orthogonal frequency division multiplexing (OFDM) demodulator 51. The OFDM demodulator 51 demodulates the digital broadcast signal and then outputs the demodulated digital broadcast signal to the signal processor 47.

The antenna 48 may also receive a terrestrial analog television signal. The received analog signal is supplied to an analog tuner 68 through a distributor, which is not shown. The analog tuner 68 selects a desired analog television signal and then sends the signal to an analog demodulator 69. The analog demodulator 69 demodulates the selected analog broadcast signal and then outputs the demodulated analog broadcast signal to the signal processor 47.

The signal processor 47 performs appropriate signal processing on a digital broadcast signal output from the PSK demodulator 46 or the OFDM demodulator 51. The digital broadcast signal is separated into a data signal, a video signal, and an audio signal. The resulting video signal is then output to a graphic processor 52 and the resulting audio signal is output to an audio processor 53. The signal processor 47 converts a broadcast signal output from the analog demodulator 69 or an input signal from line input terminals into digital video and audio signals of predetermined formats. The resulting digital video and audio signals are then output to the graphic processor 52 and the audio processor 53, respectively.

An on-screen display (OSD) signal generator 54 generates an OSD signal to display a user interface (UI) screen or the like under the control of the controller 56. The data signal separated from the digital broadcast signal by the signal processor 47 is converted by the OSD signal generator 54 into an OSD signal of a proper format and then supplied to the graphic processor 52.

The graphic processor 52 decodes the digital video signal output from the signal processor 47. The decoded video signal is combined with an OSD signal output from the OSD signal generator 54 and then output to the display processor 55. The graphic processor 52 can also selectively output the decoded video signal or the OSD signal to the display processor 55. Moreover, the video signal and the OSD signal can be combined and output so that each of them makes up a half of the screen.

The display processor 55 converts a signal input from the graphic processor 52 into an analog video signal of a format which can be displayed by a display device 14. The resulting video signal is output to the display device 14 to be displayed.

The audio processor 53 converts an input audio signal into an analog audio signal of a format which a speaker 15 can reproduce. The resulting analog audio signal is supplied to the speaker 15 and reproduced.

A card holder 61 is connected to the controller 56 through a card interface 60. A first memory card 19 can be slotted into the card holder 61. The first memory card 19 is a storage medium, such as a Secure Digital (SD) memory card, Multimedia Card (MMC) or Memory Stick. Between the first memory card 19 inserted into the card holder 61 and the controller 56, information transfer can be made via the card interface 60. The controller 56 can write data such as image data, audio data and data of a broadcast program into the first memory card 19. In addition, the controller 56 can read image data, audio data or data of a broadcast program from the first memory card 19 and display the read data on the display device 14 and/or reproduce the read data with the speaker 15.

A card holder 63 is connected to the controller 56 through a card interface 62. A second memory card 20 can be plugged into the card holder 63. The second memory card 20 is a storage medium to store contract information concerning broadcast subscription, for example. Between the second memory card 20 inserted into the card holder 63 and the controller 56, information transfer can be made via the card interface 62.

A first LAN terminal 21 is connected to the controller 56 through a communication interface 64. The first LAN terminal 21 is used as a port dedicated to a hard disk drive (HDD) which is in conformity with a local area network (LAN) using Ethernet (registered trade mark). When a LAN-based HDD is connected to the first LAN terminal 21 as network attached storage (NAS), the HDD and the controller 56 can make information transfer via the communication interface 64. In this case, the controller 56 functions as a dynamic host configuration protocol (DHCP) server and controls the information transfer assigning an Internet Protocol (IP) address to the LAN-based HDD connected to the first LAN terminal 21.

The controller 56 can store data such as image data, audio data and data of a broadcast program into the HDD. Moreover, the controller 56 can read data from the HDD and display the read data on the display device 14 and/or reproduce the read data with the speaker 15. Since the first LAN terminal 21 is provided as a port dedicated to the LAN-based HDD, information of a broadcast program can be recorded in high-definition television quality on the HDD, without being affected by other network environments or network usage status.

A second LAN terminal 22 is connected to the controller 56 through a communication interface 65. The second LAN terminal 22 is used as a common port which is in conformity with a LAN using Ethernet. A device such as a LAN-based HDD, a personal computer (PC) and a digital versatile disk (DVD) recorder with a built-in HDD is connected to the second LAN terminal 22 using a hub, for example. Transfer of information can be made between the device connected to the second LAN terminal 22 and the controller 56 via the communication interface 65. In the case in which a broadband router is connected to the second LAN terminal 22 through the hub, the controller 56 can connect with a network such as the Internet via that broadband router. PCs and mobile phones are connected to the network and can communicate with the broadcast receiving apparatus 11.

A storage medium such as a hard disk and a DVD (or an optical disk) can be placed into the device, e.g., the HDD, PC, or DVD recorder, connected to the controller 56 via the communication interface 65. The controller 56 can write data such as image data, audio data and data of a broadcast program in the storage medium through the hub and the device connected to the hub. In addition, the controller 56 can read image data, audio data or data of a broadcast program from the storage medium and display the read data on the display device 14 and/or reproduce the read data with the speaker 15.

A universal serial bus (USB) terminal 23 is connected to the controller 56 through a USB interface 66. The USB terminal 23 is used as a common USB-based port. Connected to the USB terminal 23 via a hub is a device such as a cellular phone, a digital camera, a card reader/writer for a memory card, an HDD and a keyboard. The controller 56 can send and receive information to and from the device connected to the USB terminal 23.

An i.Link (registered trade mark) terminal 24 is connected to the controller 56 through an i.Link interface 67. A device such as an AV-HDD, a digital video home system (D-VHS) or the like is serial-connected to the i.Link terminal 24. The controller 56 can send and receive information to and from the device connected via the i.Link terminal 24 and the i.Link interface 67.

Next, the operation of the broadcast receiving apparatus 11 having the above configuration will be described.

The broadcast receiving apparatus 11 according to the present embodiment displays various content (e.g., an OSD screen, an electronic program guide, a Web page, a broadcast program received by antenna 43 or 48, a program delivered over the network, image data) in a single window and changes displayed content using tabs. Therefore, memory and system resources can be saved as compared with the case in which windows are set up for the respective content.

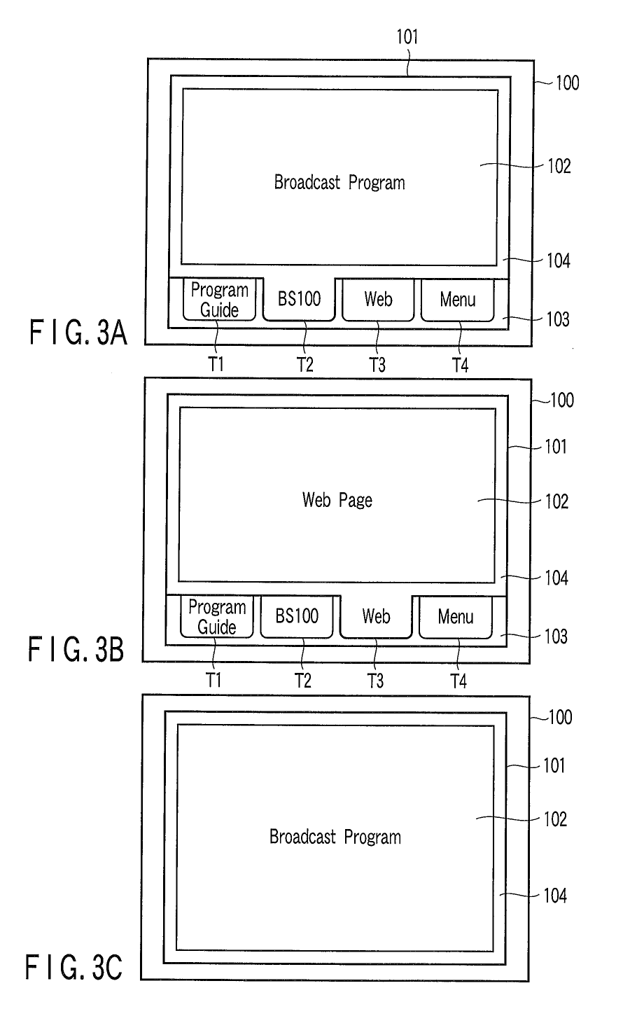

FIGS. 3A, 3B and 3C are exemplary views showing display examples of a display area 100 of the display device 14 according to the first embodiment. As shown in FIG. 3A, a window 101 is set up on the display area 100 of the display device 14. Various kinds of content can be displayed in a content display area 102 within the window 101. Tabs (four tabs T1 to T4 in this embodiment) are displayed side by side in a tab display area 103 arranged under the content display area 102. On each of the tabs, character information (or an icon) indicating corresponding display content such as channel information of a broadcast program is displayed. When one of the tabs displayed in the tab display area 103 is selected by a user, display content corresponding to the selected tab is displayed in the content display area 102. Since the tab T2 is selected in FIG. 3A, display content corresponding to the tab T2 (broadcast program) is displayed in the content display area 102. In the description which follows, a tab which is selected by the user and whose corresponding display content is displayed in the content display area 102 is referred to as “current tab.” The current tab is emphasized so that the tab is integrated with a content frame 104 as shown in FIG. 3A or the color of the current tab is different from other tabs.

A user may scroll and browse the content displayed in the content display area 102 by operating the first direction key 17f mounted on the remote controller 17. In addition, the user can change the content to be displayed in the content display area 102 or change a display form of the tabs by operating any of the second direction keys 17g (RIGHT key 17h, LEFT key 17i, UP key 17j, and DOWN key 17k).

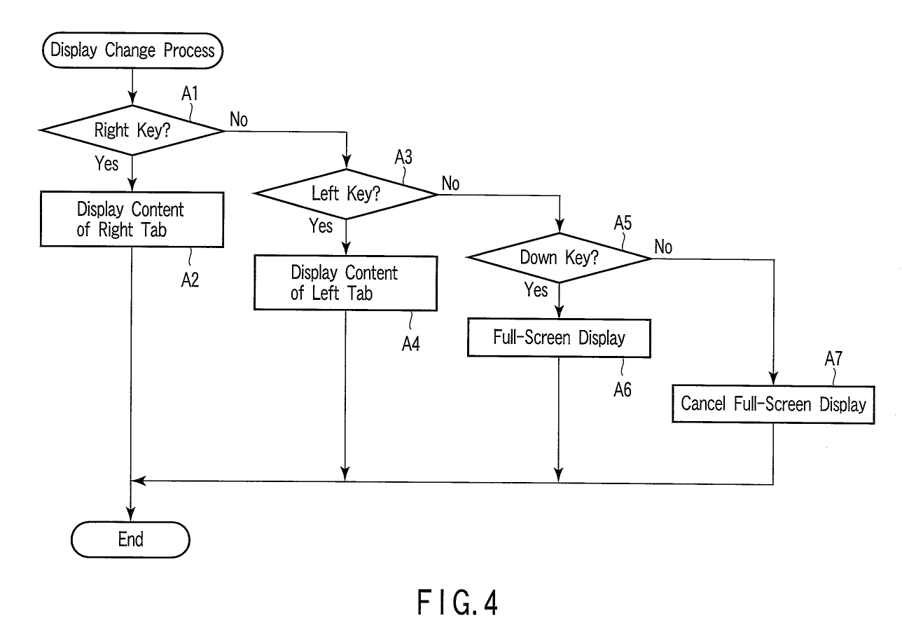

FIG. 4 is an exemplary flowchart of a display change process according to the first embodiment.

This display change process is started when the user operates any key of the second direction keys 17g mounted on the remote controller 17.

The controller 56 determines whether or not a key operated by the user is the RIGHT key 17h (block A1). When the user operates the RIGHT key 17h (“YES” in block A1), the controller 56 displays content corresponding to the immediate right tab of the current tab in the content display area 102 and emphasizes the immediate right tab in place of the current tab (block A2). That is, the immediate right tab is selected as a new current tab. When the user operates the RIGHT key 17h in the state in which the display screen of FIG. 3A is being displayed in the display area 100, the display state of the display area 100 is updated as shown in FIG. 3B. In FIG. 3A, the tab T2 is selected as the current tab and displayed with emphasis, and in addition, the display content corresponding to the tab T2 (broadcast program) is displayed in the content display area 102. Therefore, when the user operates the RIGHT key 17h, the tab T3 which is the immediate right tab of the tab T2 is emphasized instead of the tab T2 and the display content corresponding to the tab T3 (web page) is displayed in the content display area 102.

When the user operates the RIGHT key 17h in the state in which the rightmost tab T4 is selected and displayed highlighted as the current tab, there is no tab on the right of the tab T4. In such a case, the leftmost tab T1 is cyclically considered to be the right tab of the tab T4 and emphasized. Moreover, the display content corresponding to the tab T1 (electronic program guide, in the examples of FIGS. 3A to 3C) is displayed in the content display area 102.

On the other hand, when it is determined that the key operated by the user is not the RIGHT key 17h (“NO” in block A1), then the controller 56 determines whether or not the key operated by the user is the LEFT key 17i (block A3). When the user operates the LEFT key 17i (“YES” in block A3), the controller 56 displays content corresponding to the tab which is immediate left tab of the current tab in the content display area 102 and displays the immediate left tab with emphasis in place of the current tab (block A4). That is, the immediate left tab is selected as the new current tab. When the user operates the LEFT key 17i in the state in which the display screen of FIG. 3A appears in the display area 100, the tab T1 which is the immediate left tab of the tab T2 is emphasized instead of the tab T2 and the content display area 102 displays the display content corresponding to the tab T1 (electronic program guide).

When the user operates the LEFT key 17i in the state in which the leftmost tab T1 is selected and emphasized as the current tab, the rightmost tab T4 is cyclically considered to be the left tab of the tab T1 and emphasized. In addition, display content corresponding to the tab T4 (menu screen, in the examples of FIGS. 3A to 3C) comes to be displayed in the content display area 102.

When it is determined that the key operated by the user is not the LEFT key 17i (“NO” in block A3), then the controller 56 determines whether or not the key operated by the user is the DOWN key 17k (block A5). When the user operates the DOWN key 17k (“YES” in block A5), the controller 56 causes the tab display area 103 to disappear and displays full-screen the content display area 102 (block A6). When the user operates the DOWN key 17k in the case in which the display area 100 displays the display screen of FIG. 3A, the display screen of the display area 100 is updated as shown in FIG. 3C. That is, the tab display area 103 disappears from the window 101 and the content display area 102, which is displaying the content corresponding to the current tab T2 (broadcast program), is enlarged all over the window 101.

When the user operates the DOWN key 17k in the state in which the content display area 102 has already been full-screen displayed (display state of FIG. 3C), the display state of the display area 100 remains unchanged.

When it is determined that the key operated by the user is not the DOWN key 17k (“NO” in block A5), the controller 56 determines that the key operated by the user is the UP key 17j. When the user operates the UP key 17j, the controller 56 cancels the full-screen display of the content display area 102 and restores the tab display area 103 which has been vanished (block A7). That is, the display area 100 is restored from the display state shown in FIG. 3C to the display state of FIG. 3A. When the user operates the UP key 17j in the state in which the tab display area 103 is displayed (display state shown in either FIG. 3A or FIG. 3B), the display area 100 remains unchanged. In the first embodiment, the current tab which is selected can be shifted from left to right or vice versa by operating the RIGHT key 17h or the LEFT key 17i of the second direction keys 17g. Each of the RIGHT key 17h and the LEFT key 17i is marked with a symbol indicating a corresponding direction. The user can make tab selection by referring to the symbols, and thus, the operation can be intuitively understandable.

In addition, when the DOWN key 17k is operated, the content display area 102 is expanded downward and full-screen displayed in the window 101. When the UP key 17j is operated, the content display area 102 is shortened upward to cancel the full-screen display. The DOWN key 17k is marked with a symbol to indicate the downward direction, while the UP key 17j is marked with a symbol to indicate the upward direction. The user may refer to the symbols to set or cancel the full-screen display of the content display area. Thus, the user can easily make intuitive operations.

The first embodiment is configured so that the operation of the DOWN key 17k causes the tab display area 103 to disappear and the content display area 102 to appear entirely in the window 101 (full-screen display of the content display area). However, such configuration is possible that the content display area 102 is enlarged stepwise and also the tab display area 103 is reduced stepwise in response to an operation of the DOWN key 17k; accordingly, display ratio between the content display area 102 and the tab display area 103 changes stepwise. Likewise, the content display area 102 may be reduced stepwise according to an operation of the UP key 17j. The user may refer to the symbols marked on the UP key and the DOWN key indicating the directions and enlarges or reduces stepwise the content display area 102.

Hereinafter, other embodiments of the content display apparatus of the invention will be described. In the description which follows, the same (or equivalent) elements as in the first embodiment are denoted by the same reference numerals to simplify the description.

### Second Embodiment

The electronic configuration of the second embodiment is identical to that of the first embodiment and description thereof will be omitted.

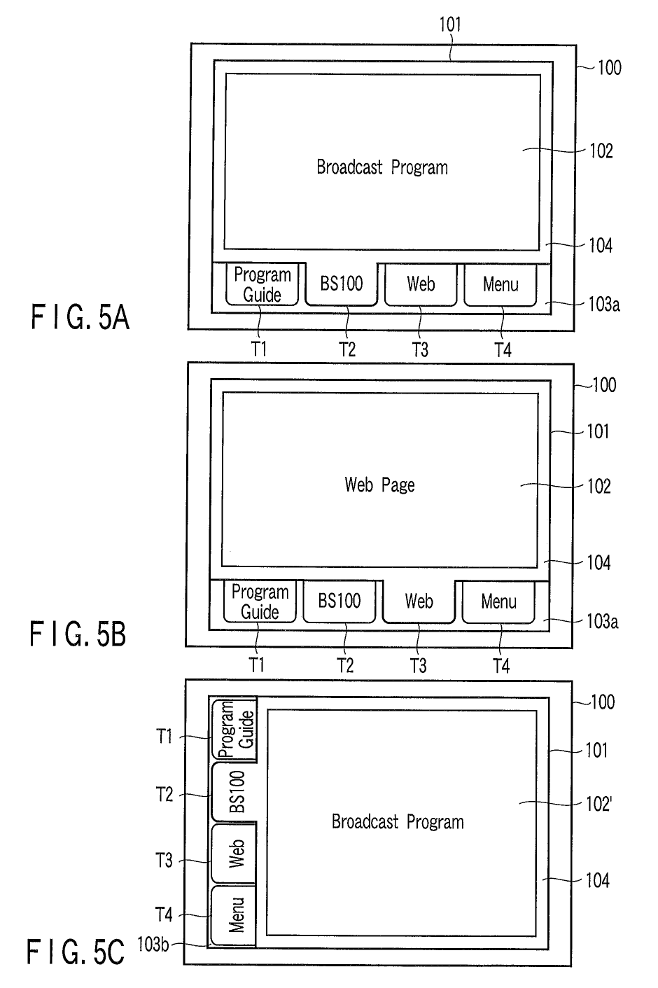

FIGS. 5A, 5B and 5C are exemplary views showing display examples of the display area 100 of the display device 14 according to the second embodiment. As with the first embodiment, the window 101 is set up on the display area 100 of the display device 14. Various kinds of content can be displayed in the content display area 102 within the window 101. A tab display area 103a which is rectangular in shape is arranged at the bottom of the window 101. Tabs (four tabs T1 to T4 in this embodiment) are displayed side by side in the tab display area 103a. On each of the displayed tabs, character information (or an icon) indicating corresponding display content such as channel information of a broadcast program is displayed. When one of the tabs displayed in the tab display area 103a is selected by a user, display content corresponding to the selected tab is displayed in the content display area 102. Since the tab T2 is selected in FIG. 5A, display content corresponding to the tab T2 (broadcast program) is displayed in the content display area 102. A tab which is selected by the user and whose corresponding display content is being displayed in the content display area 102 is referred to as “current tab.” The selected current tab is emphasized in such a manner that the current tab is integrated with the content frame 104 as shown in FIG. 5A or the color of the current tab is different from other tabs.

A user may scroll and browse the content displayed in the content display area 102 by operating the first direction key 17f mounted on the remote controller 17. Moreover, the user can change the content to be displayed in the content display area 102 or change a display form of the tabs by operating any key of the second direction keys 17g (RIGHT key 17h, LEFT key 17i, UP key 17j, and DOWN key 17k).

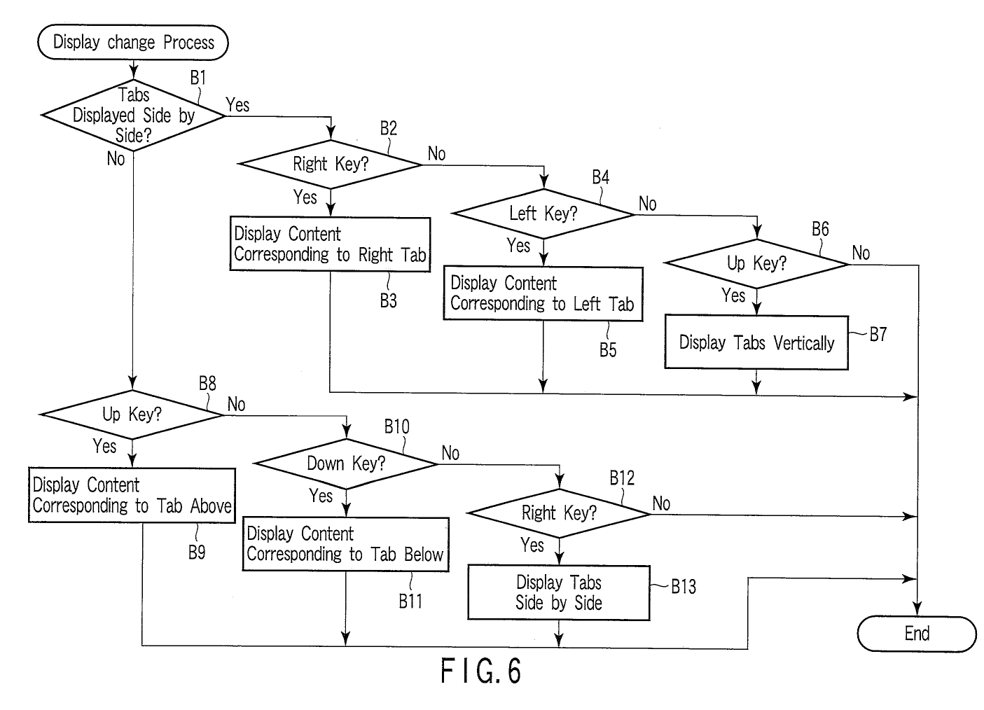

FIG. 6 is an exemplary flowchart of a display change process according to the second embodiment.

This display change process is started when the user operates any key of the second direction keys 17g mounted on the remote controller 17.

The controller 56 determines whether or not the tabs are displayed side by side in the tab display area 103a (block B1). When the tabs are displayed side by side in the tab display area 103a as shown in FIG. 5A or 5B (“YES” in block B1), the controller 56 then determines whether or not the key operated by the user is the RIGHT key 17h (block B2). When the user operates the RIGHT key 17h (“YES” in block B2), the controller 56 displays content corresponding to the immediate right tab of the current tab in the content display area 102 and displays the immediate right tab with emphasis in place of the current tab (block B3). That is, the immediate right tab is selected as a new current tab. When the user operates the RIGHT key 17h in the state in which the display screen of FIG. 5A appears in the display area 100, the display state of the display area 100 is updated as shown in FIG. 5B. In FIG. 5A, the tab T2 is selected and emphasized as the current tab and the display content corresponding to the tab T2 (broadcast program) is displayed in the content display area 102. Therefore, in response to the operation of the RIGHT key 17h, the tab T3 which is the immediate right tab of the tab T2 comes to be emphasized in place of the tab T2 and the content display area 102 becomes to display the display content corresponding to T3 (web page).

When the user operates the RIGHT key 17h in the state in which the rightmost tab T4 is selected and displayed highlighted as the current tab, there is no tab on the right of the tab T4. In such a case, the leftmost tab T1 is cyclically considered to be the right tab of the tab T4 and emphasized; moreover, the content corresponding to the tab T1 (electronic program guide in the examples of FIGS. 5A to 5C) comes to be displayed in the content display area 102.

On the other hand, when it is determined that the key operated by the user is not the RIGHT key 17h (“NO” in block B2), then the controller 56 determines whether or not the key operated by the user is the LEFT key 17i (block B4). When the user operates the LEFT key 17i (“YES” in block B4), the controller 56 displays content corresponding to the immediate left tab of the current tab in the content display area 102 and emphasizes the immediate left tab instead of the current tab (block B5). That is, the immediate left tab is selected as the new current tab. When the user operates the LEFT key 17i in the state in which the display screen of FIG. 5A appears in the display area 100, the tab T1 which is the immediate left tab of the tab T2 is emphasized in place of the tab T2 and the display content corresponding to the tab T1 (electronic program guide) is displayed in the content display area 102.

When the user operates the LEFT key 17i in the state in which the leftmost tab T1 is selected and highlight-displayed as the current tab, the rightmost tab T4 is cyclically selected as the left tab of the tab T1 and emphasized. In addition, display content corresponding to the tab T4 (menu screen, in the examples of FIGS. 5A to 5C) is brought to be displayed in the content display area 102.

When it is determined that the key operated by the user is not the LEFT key 17i (“NO” in block B4), then the controller 56 determines whether or not the key operated by the user is the UP key 17j (block B6). When the user operates the UP key 17j (“YES” in block B6), the controller 56 changes the display so that the tabs come to be displayed in a tab display area 13b provided at a left portion of the window 101 (block B7). When the user operates the UP key 17j in the state in which the display screen of FIG. 5A appears in the display area 100, the display area 100 is updated as shown in FIG. 5C. That is, the area which displays the tabs T1 to T4 is changed from the tab display area 103a that is arranged at the bottom of the window 101 and has a horizontally long rectangular shape to the tab display area 103b that is arranged at the left portion in the window 101 and has a vertically long rectangular shape. Unlike the tab display area 103a in which the tabs T1 to T4 are arranged side by side, the tabs are arranged in a vertical column in the tab display area 103b. The display content corresponding to the current tab T2 (broadcast program) is displayed in a content display area 102′ which is arranged to the right of the tab display area 103b.

When the DOWN key 17k is operated (“NO” in step B6), the display state of the display area 100 remains unchanged and the process is complete.

On the other hand, when any key of the second direction keys 17g is operated in the case in which the tabs are displayed vertically in the tab display area 103b as shown in FIG. 5C (“NO” in block B1), the controller 56 determines whether or not the key operated by the user is the UP key 17j (block B8). When the user operates the UP key 17j (“YES” in block B8), the controller 56 displays content corresponding to the tab which is immediately above the current tab and emphasizes the tab immediately above in place of the current tab (block B9). That is, the tab immediately above is selected as the new current tab. When the user operates the UP key 17j in the state in which the display area 100 shows the display screen of FIG. 5C, the tab T1 that is immediately above the current tab T2 comes to be emphasized in place of the tab T2. In addition, display content corresponding to the tab T1 (electronic program guide) is brought to be displayed in the content display area 102′.

When the user operates the UP key 17j in the state in which the topmost tab T1 is selected and emphasized as the current tab, the bottommost tab T4 becomes to be emphasized as a new current tab and corresponding display content (menu screen, in the example of FIG. 5C) is displayed in the content display area 102′.

When it is determined that the key operated by the user is not the UP key 17j (“NO” in block B8), then the controller 56 determines whether or not the key operated by the user is the DOWN key 17k (block B10). When the user operates the DOWN key 17k (“YES” in block B10), the controller 56 displays content corresponding to the tab immediately below the current tab in the content display area 102′ and emphasizes the tab immediately below instead of the current tab (block B11). That is, the tab immediately below the current tab is selected as the new current tab. When the user operates the DOWN key 17k in the state in which the display screen of FIG. 5C appears in the display area 100, the tab T3 that is immediately below the current tab T2 is highlight-displayed in place of the tab T2. In addition, the display content corresponding to the tab T3 (Web page) comes to be displayed in the content display area 102′.

When the user operates the DOWN key 17k in the state in which the bottommost tab T4 is selected and emphasized as the current tab, the topmost tab T1 becomes to be emphasized as a new current tab and display content corresponding to the tab T1 (electronic program guide, in the example of FIG. 5C) is displayed in the content display area 102′.

When it is determined that the key operated by the user is not the DOWN key 17k (“NO” in block B10), then the controller 56 determines whether or not the key operated by the user is the RIGHT key 17h (block B12). When the user operates the RIGHT key 17h (“YES” in block B12), the controller 56 changes the display so that the tabs comes to be displayed in the tab display area 13a arranged at the bottom of the window 101 (block B13). When the user operates the RIGHT key 17h in the state in which the display area 100 displays the display screen of FIG. 5C, the display area 100 is updated as shown in FIG. 5A. That is, the area in which the tabs T1 to T4 are displayed is changed from the tab display area 103b, which is arranged at the left portion in the window 101 and in the vertically long rectangular shape, to the tab display area 103a, which is arranged at the bottom of the window 101 and in the horizontally long rectangular shape. Unlike the tab display area 103b in which the tabs T1 to T4 are arranged vertically, the tabs are arranged side by side in the tab display area 103a. The display content corresponding to the current tab T2 (broadcast program) is displayed in the content display area 102 which is above the tab display area 103a. When the LEFT key 17i is operated (“NO” in block B12), the display state of the display area 100 remains unchanged and the procedure is complete.

In the second embodiment, the current tab can be shifted from left to right or vice versa by operating the RIGHT key 17h or the LEFT key 17i of the second direction keys 17g in the case in which the tabs are displayed side by side in the tab display area 103a. Each of the RIGHT key 17h and the LEFT key 17i is marked with a symbol indicating a corresponding direction. The user can intuitively select tabs with reference to the symbols.

Furthermore, operating the UP key 17j changes the area in which the tabs are displayed from the tab display area 103a that is at the bottom of the window 101 to the tab display area 103b that is in the left portion of the window 101. The UP key 17j is marked with a symbol indicating the upward direction. The user can intuitively change the area to display the tabs with reference to the symbol.

When the tabs are displayed vertically in the tab display area 103b, the current tab can be shifted up or down by operating the UP key 17j or the DOWN key 17k of the second direction keys 17g. Each of the UP key 17j and the DOWN key 17k is marked with a symbol to indicate a corresponding direction. The user can intuitively shift the current tab with reference to the symbols.

In addition, operating the RIGHT key 17h changes the tab displaying area from the tab display area 103b that is arranged in the left portion of the window 101 to the tab display area 103a that is arranged at the bottom of the window 101. The user can intuitively make the tab operation by referring to the symbol.

In the second embodiment, when the DOWN key 17h is operated in the case where the tabs T1 to T4 are arranged side by side in the tab display area 103a, the display state of the display area 100 remains unchanged and the process is terminated. However, the second embodiment may be configured so that operating the DOWN key 17h while the tabs T1 to T4 are arranged side by side in the tab display area 103a causes full-screen display of the content display area 102 in the window 101 as in the first embodiment. Namely, the content display area 102 may be expanded downward in response to the operation of the DOWN key 17h, and the operation is intuitively understandable.

In the second embodiment, when the LEFT key 17i is operated in the case where the tabs T1 to T4 are arranged vertically in the tab display area 103b, the display state of the display area 100 remains unchanged and the process is terminated. However, it may be configured in such a manner that operating the LEFT key 17i while the tabs T1 to T4 are arranged vertically in the tab display area 103b causes the full-screen display of the content display area 102′ in the window 101. That is, the operation of the LEFT key 17i expands the content display area 102′ to the left, and the operation is intuitively understandable operation.

### Third Embodiment

The electronic configuration of the third embodiment is identical to that of the first embodiment and description thereof will be omitted.

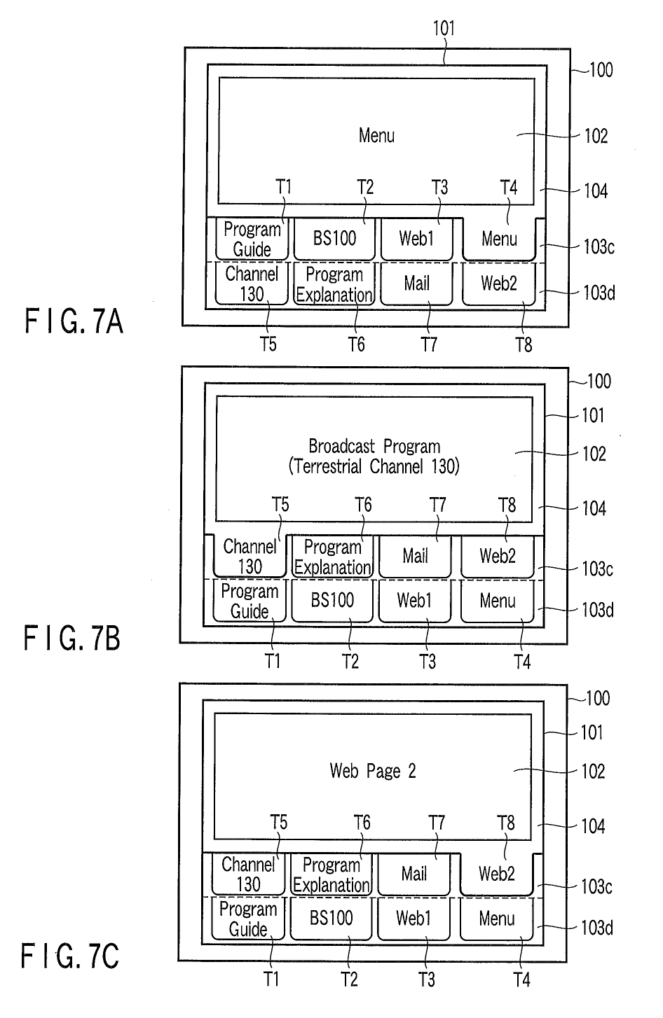

FIGS. 7A, 7B and 7C are exemplary views showing display examples of the display area 100 of the display device 14 according to the third embodiment. As with the first embodiment, the window 101 is set up on the display area 100 of the display device 14.

Various kinds of content can be displayed in the content display area 102 within the window 101. At the bottom of the window 101, provided are an upper tab display area 103c and a lower tab display area 103d. Tabs (four tabs T1 to T4 in this embodiment) are displayed side by side in the upper tab display area 103c. In the lower tab display area 103d as well, tabs T5 to T8, which correspond in number to the tabs displayed in the upper tab display area 103d, are displayed side by side. On each of the displayed tabs, character information (or an icon) indicating corresponding display content such as channel information of a broadcast program is displayed. When one of the tabs displayed in the tab display areas 103c and 103d is selected by the user, display content corresponding to the selected tab is displayed in the content display area 102. Since the tab T4 is selected in FIG. 7A, display content corresponding to the tab T4 (menu screen) is displayed in the content display area 102. A tab which is selected by the user and whose corresponding display content is displayed in the content display area 102 is referred to as “current tab.” The selected current tab is emphasized in such a manner that the current tab is integrated with the content frame 104 as shown in FIG. 7A or the color of the current tab is different from other tabs.

A user may scroll and browse the content displayed in the content display area 102 by operating the first direction key 17f mounted on the remote controller 17. Moreover, the user can change the content to be displayed in the content display area 102 or change a display form of the tabs by operating any key of the second direction keys 17g (RIGHT key 17h, LEFT key 17i, UP key 17j, and DOWN key 17k).

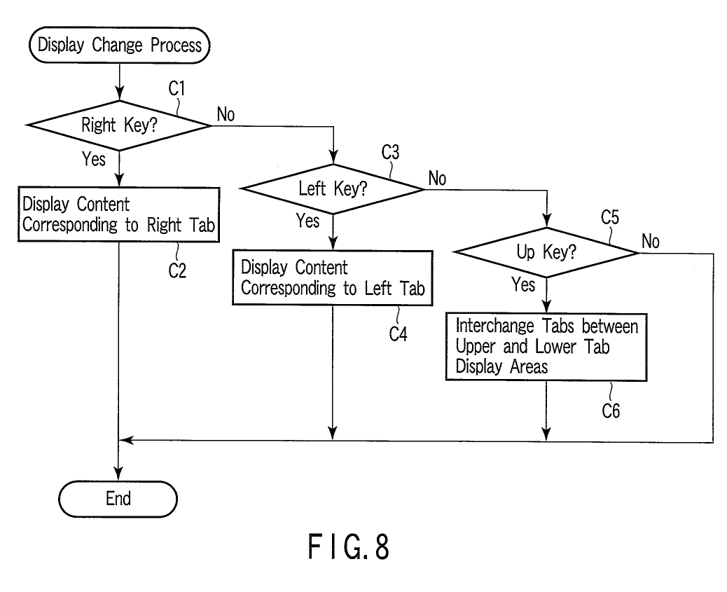

FIG. 8 is an exemplary flowchart of a display change process according to the third embodiment.

This display change process is started when the user operates any key of the second direction keys 17g mounted on the remote controller 17.

The controller 56 determines whether or not the key operated by the user is the RIGHT key 17h (block C1). When the user operates the RIGHT key 17h (“YES” in block C1), the controller 56 displays content corresponding to the immediate right tab of the current tab in the content display area 102 and displays the immediate right tab with emphasis in place of the current tab (block C2). That is, the immediate right tab is selected as a new current tab. It should be noted that the immediate right tab of the tab T8 is considered to be the tab T1 and the immediate right tab of the tab T4 is considered to be the tab T5.

When the user operates the RIGHT key 17h in the state in which the rightmost tab T4 is selected as the current tab and displayed with emphasis as shown in FIG. 7A, there is no tab on the right of the tab T4. In such a case, the tab T5 is considered to be the immediate right tab of the tab T4 and the display state of the display area 100 is updated as shown in FIG. 7B. The controller 56 interchanges the tabs between the upper tab display area 103c and the lower tab display area 103d, so that the tabs T1 to T4 which have been displayed in the upper tab display area 103c come to be displayed in the lower tab display area 103d and the tabs T5 to T8 which have been displayed in the lower tab display area 103d become to be displayed in the upper tab display area 103c. In addition, the tab T5 which is considered to be the immediate right tab of the current tab T4 is emphasized in the upper tab display area 103c. Content corresponding to the tab T5 (broadcast program in the examples of FIGS. 7A to 7C) is displayed in the content display area 102.

When it is determined that the key operated by the user is not the RIGHT key 17h (“NO” in block C1), then the controller 56 determines whether or not the key operated by the user is the LEFT key 17i (block C3). When the user operates the LEFT key 17i (“YES” in block C3), the controller 56 displays content corresponding to the immediate left tab of the current tab in the content display area 102 and emphasizes the immediate left tab in place of the current tab (block C4). That is, the immediate left tab is selected as the new current tab. It should be noted that the immediate left tab of the tab T5 is considered to be the tab T4 and the tab T8 is considered as the immediate left tab of the tab T1.

When the user operates the LEFT key 17i in the state in which the leftmost tab T5 in the upper tab display area 103c is selected and emphasized as shown in FIG. 7B, there is no tab on the left of the tab T5. In such a case, the tab T4 is considered as the immediate left tab of the tab T5 and the display state of the display area 100 returns to the state shown in FIG. 7A. The controller 56 interchanges the tabs between the upper and lower tab display areas with the result that the tabs T5 to T8 which have been displayed in the upper tab display area 103c become to be displayed in the lower tab display area 103d and the tabs T1 to T4 which have been displayed in the lower tab display area 103d come to appear in the upper tab display area 103c. The tab T4 which is considered as the immediate left tab of the current tab T5 is emphasized in the upper tab display area 103c. In the content display area 102, content corresponding to the tab T4 (menu screen) is displayed.

When it is determined that the key operated by the user is not the LEFT key 17i (“NO” in block C3), then the controller 56 determines whether or not the key operated by the user is the UP key 17j (block C5). When it is determined that the key operated by the user is the UP key 17j (“YES” in block C5), then the controller 56 interchanges the tabs displayed in the upper tab display area 103c and the tabs displayed in the lower tab display area 103d. Accordingly the tabs which have been displayed in the upper tab display area 103c come to be displayed in the lower tab display area 103d and the tabs which have been displayed in the lower tab display area 103d become to be displayed in the upper tab display area 103c (block C6).

When the user operates the UP key 17j in the state in which the display screen of FIG. 7A appears in the display area 100, the display area 100 is updated as shown in FIG. 7C. That is, the tabs are interchanged between the upper and lower display areas in such a manner that the tabs T1 to T4 which have been displayed in the upper tab display area 103c are brought to be displayed in the lower tab display area 103d and the tabs T5 to T8 which have been displayed in the lower tab display area 103d are brought to be displayed in the upper tab display area 103c. The tab T8 has been displayed immediately below the current tab T4 in FIG. 7A; therefore in FIG. 7C, the tab T8 becomes to be taken as the current tab and emphasized in the upper tab display area 103c. Alternatively, the leftmost tab T5 in the upper tab display area 103c may be selected as the new current tab.

On the other hand, when it is determined that the key operated by the user is not the UP key 17j (NO in block C5), then the controller 56 determines that the key operated by the user is the DOWN key 17k. When the user operates the DOWN key 17k, the display state of the display area 100 remains unchanged and the process is terminated.

In the third embodiment, the current tab can be shifted from left to right or vice versa by operating the RIGHT key 17h or the LEFT key 17i of the second direction keys 17g. Each of the RIGHT key 17h and the LEFT key 17i is marked with a symbol indicating a corresponding direction. The user can intuitively operate the keys to shift the tabs with reference to the symbols.

In addition, operating the UP key 17j allows the tabs T5 to T8 which have been displayed in the lower tab display area 103d to appear up in the upper tab display area 103c (tabs T5 to T8 move upward). The user can interchange the tabs displayed above and tabs displayed below by referring to the symbol indicating the upward direction on the UP key 17j, and thus intuitive operation can be made.

In the third embodiment, when the DOWN key 17k is operated, the process is terminated without display change. However, the display state of the display area 100 may be changed in response to the operation of the DOWN key 17k. For example, when the DOWN key 17k is operated, the lower tab display area 103d may disappear, and only the content display area 102 and the upper tab display area 103c may be displayed in the window 101. In this case, the content display area 102 and the upper tab display area 103c expand downward in response to the operation of the down key 17k; therefore, such operation is intuitively understandable. Alternatively, the content display area 102 may be full-screen displayed in the window 101 in response to the operation of the down key 17h. In this case, the content display area 102 expands downward in response to the DOWN key 17k; therefore such operation is also intuitively understandable.

Alternatively, the tabs displayed in the upper tab display area 103c and the tabs displayed in the lower tab display area 103d may be interchanged when the DOWN key 17k is operated.

### Fourth Embodiment

The electronic configuration of the fourth embodiment is identical to that of the first embodiment and description thereof will be omitted.

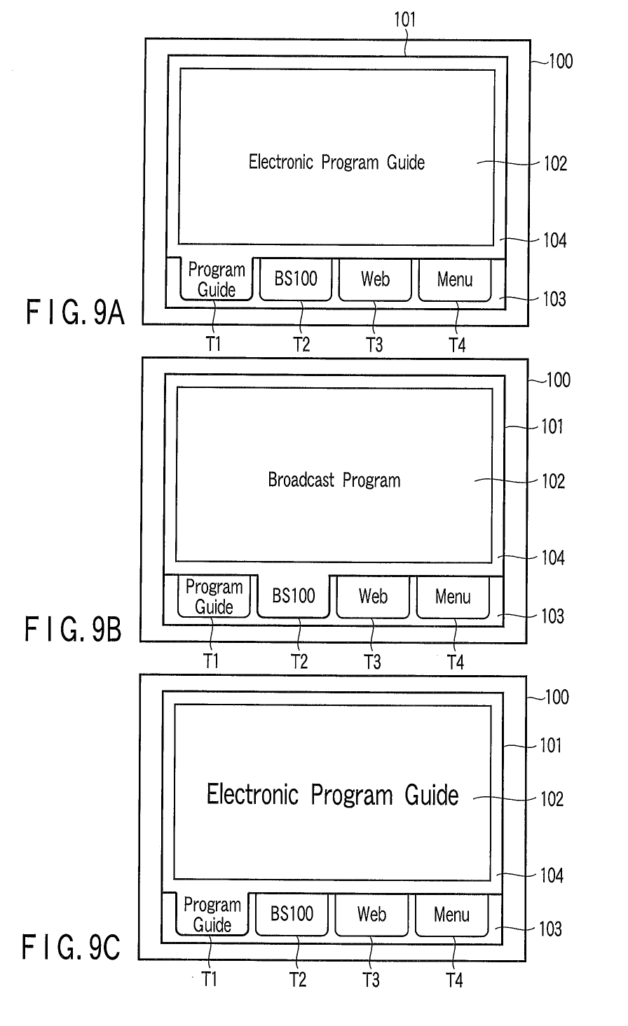

FIGS. 9A, 9B and 9C are exemplary views showing display examples of the display area 100 of the display device 14 according to the fourth embodiment. As with the first embodiment, the window 101 is set up on the display area 100 of the display device 14. Various kinds of content can be displayed in the content display area 102 within the window 101. The tab display area 103 is arranged at the bottom of the window 101. Tabs (four tabs T1 to T4 in this embodiment) are displayed side by side in the tab display area 103. Character information (or an icon) indicating corresponding display content such as channel information of a broadcast program is displayed on each of the displayed tabs. When one of the tabs displayed in the tab display areas 103 is selected by the user, content corresponding to the selected tab is displayed in the content display area 102. Since the tab T1 is selected in FIG. 9A, display content corresponding to the tab T1 (electronic program guide) is displayed in the content display area 102. A tab which is selected by the user and whose corresponding display content is displayed in the content display area 102 is referred to as “current tab.” The selected current tab is emphasized in such a manner that the current tab is integrated with the content frame 104 as shown in FIG. 9A or the color of the current tab is different from other tabs.

A user may scroll and browse the content displayed in the content display area 102 by operating the first direction key 17f mounted on the remote controller 17. Moreover, the user can change the content to be displayed in the content display area 102 or change a display form of the tabs by operating any key of the second direction keys 17g (RIGHT key 17h, LEFT key 17i, UP key 17j, and DOWN key 17k).

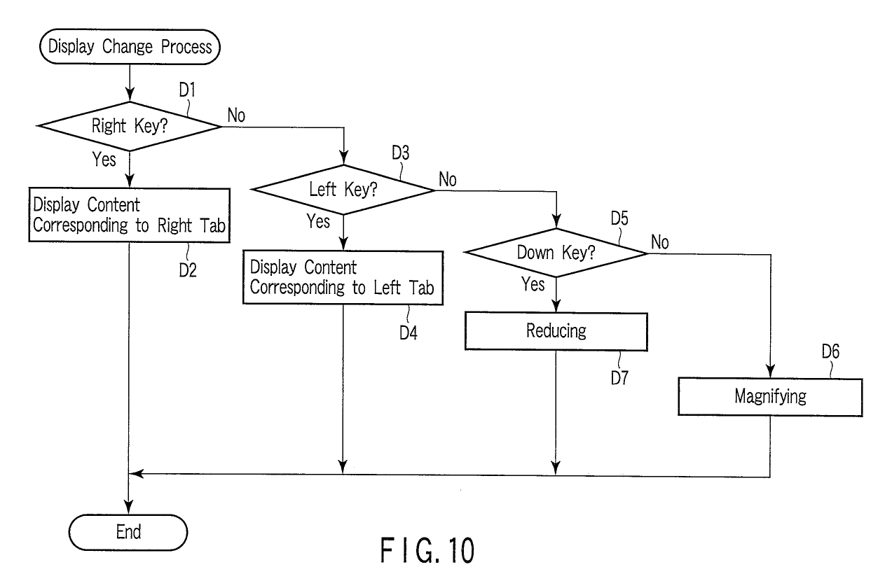

FIG. 10 is an exemplary flowchart of a display change process according to the fourth embodiment.

This display change process is started when the user operates any key of the second direction keys 17g mounted on the remote controller 17.

The controller 56 determines whether or not the key operated by the user is the RIGHT key 17h (block D1). When the user operates the RIGHT key 17h (“YES” in block D1), the controller 56 displays content corresponding to the immediate right tab of the current tab in the content display area 102 and emphasizes the immediate right tab instead of the current tab (block D2). That is, the immediate right tab is taken as a new current tab. When the user operates the RIGHT key 17h in the state in which the display screen of FIG. 9A appears in the display area 100, the display area 100 is updated as shown in FIG. 9B. In FIG. 9A, the tab T1 is selected and emphasized as the current tab; accordingly, the display content corresponding to the tab T1 (electronic program guide) is displayed in the content display area 102. Therefore, when the user operates the RIGHT key 17h, the tab T2 which is the immediate right tab of the tab T1 comes to be emphasized in place of the tab T1 and display content corresponding to the tab T2 (broadcast program) is brought to be displayed in the content display area 102.

When the user operates the RIGHT key 17h in the state in which the rightmost tab T4 is selected and emphasized as the current tab, there is no tab on the right of the tab T4. In such a case, the leftmost tab T1 is cyclically considered to be the immediate right tab of the tab T4 and comes to be emphasized and display content corresponding to T1 (electronic program guide in the examples of FIGS. 9A to 9C) is brought to be displayed in the content display area 102.

When it is determined that the key operated by the user is not the RIGHT key 17h (“NO” in block D1), then the controller 56 determines whether or not the key operated by the user is the LEFT key 17i (block D3). When the user operates the LEFT key 17i (“YES” in block D3), the controller 56 displays content corresponding to the immediate left tab of the current tab in the content display area 102 and emphasizes the immediate left tab in place of the current tab (block D4). That is, the immediately left tab is set as the new current tab.

When the user operates the LEFT key 17i in the state in which the leftmost tab T1 is selected and displayed with emphasis as the current tab as shown in FIG. 9A, the rightmost tab T4 comes to be emphasized as the immediately left tab of the tab T1 and display content corresponding to the tab T4 (menu screen) is caused to be displayed in the content display area 102.

When it is determined that the key operated by the user is not the LEFT key 17i (“NO” in block D3), then the controller 56 determines whether or not the key operated by the user is the DOWN key 17k (block D5). When it is determined that the key operated by the user is not the DOWN key 17k (“NO” in block D5), then the controller 56 determines that the key operated by the user is the UP key 17j. When the user operates the UP key 17j, the controller 56 magnifies the content displayed in the content display area 102 (block D6).

When the user operates the UP key 17j in the state in which the display screen of FIG. 9A appears in the display area 100, the display area 100 is updated as shown in FIG. 9C. That is, the content corresponding to the current tab T1 (electronic program guide) comes to be magnified and displayed in the content display area 102. When the magnified display content is too large to be wholly displayed in the content display area 102, the displayed content may be scrolled with the first direction key 17f.

When the user operates the DOWN key 17k and the controller 56 determines that the key operated by the user is the DOWN key 17k (“YES” in block D5), then the controller 56 reduces the content displayed in the content display area 102 (block D7).

When the user operates the DOWN key 17k in the state in which the display screen of FIG. 9C appears in the display area 100, the display area 100 returns to the display state of FIG. 9A.

In the fourth embodiment, the current tab can be shifted from left to right or vice versa by operating the RIGHT key 17h or the LEFT key 17i of the second direction keys 17g. Each of the RIGHT key 17h and the LEFT key 17i is marked with a symbol indicating a corresponding direction. The user can shift the selected tab with reference to the symbols, and thus, intuitively understandable operations can be made.

The content displayed in the content display area 102 is magnified in response to the operation of the UP key 17j, and on the other hand, the content is reduced in response to the operation of the DOWN key 17k. Each of the UP key 17j and the DOWN key 17k is marked with a symbol indicating a corresponding direction. The user can change the display state of the display area 100 with reference to the symbols by operating the UP key 17j to magnify the content or the DOWN key 18k to reduce the content.

In the fourth embodiment, display content displayed in the content display area 102 is magnified in response to the operation of the UP key 17j and reduced in response to the operation of the DOWN key 17k. However, instead of magnifying or reducing the displayed content, character information (or an icon) displayed on the current tab (or all the displayed tabs) indicating corresponding display content may be scaled up or down.

In the embodiments described above, four tabs are displayed side by side (or vertically) in one tab display area; however, the number of displayable tabs is not limited to four. The number of tabs that can be displayed in one display area may be previously set by the user.

In the embodiments described above, display content which the content display area 102 displays includes a menu screen, an electronic program guide, for example. On the menu screen, settings on the broadcast receiving apparatus 11 can be made. When a tab corresponding to the menu screen (tab T4 in the examples of FIGS. 3A and 3B) is selected as the current tab, a predetermined menu screen appears in the content display area 102. The user may set, for example, the number of tabs that can be displayed in one display area following guidance information on the menu screen.

In addition, the user may program previously on the electronic program guide that a desired program will be started or recorded on time. When a tab corresponding to the electronic program guide (tab T1 in the examples of FIGS. 3A and 3B) is selected as the current tab, the electronic program guide is displayed in the content display area 102. The controller 56 can obtain information of the program guide from a digital broadcast signal received by antenna 43 or 48 or received over a network. The OSD signal generator 54 generates screen data of the electronic program guide based on the obtained information. The content display area 102 displays the generated data of the electronic program guide. Following the guidance contained in the screen of the electronic program guide, the user may select the desired program and make configuration so that the selected program will be started or recorded.

The content display area 102 may display a display screen for still another application. For example, when an application for creating an electronic mail is activated, an electronic mail creation screen appears in the content display area 102 and a corresponding tab (e.g., tab T7 in the examples of FIGS. 7A to 7C) is displayed in the tab display area 103.

In the embodiments described above, one window is displayed in the display area 100 of the display device 14; however, multiple windows may be displayed in the display area. A content display area 102 and a tab display area 103 may be provided for each of the windows, and above-described display change process (any of FIGS. 4, 6, 8 and 10) may be executed with respect to each window.

In the embodiments described above, the remote controller 17 is equipped with the first direction key 17f and the second direction keys 17g. The second direction keys 17g includes the RIGHT key 17h, the LEFT key 17i, the UP key 17j, and the DOWN key 17k and arranged in a ring form around and concentrically with the first direction key 17f which has a round shape. However, the first direction key 17f may have a shape other than the round shape. Also, the form of the set of second direction keys 17g is not limited to the ring shape. The RIGHT key 17h, the LEFT key 17i, the UP key 17j and the DOWN key 17k need not necessarily be separated from one another and may be integrated into one key. The second direction keys 17g may include only the RIGHT key 17h and the LEFT key 17i. In such a case, only the current tab can be shifted from right to left or vice versa.

Alternatively, first and second modes may be set and switched. Such configuration is possible that, when the first mode is set, the selected tab is changed by operating the RIGHT key 17h or the LEFT key 17i, and when the second mode is set, the RIGHT key 17h or the LEFT key 17i may function similarly to the UP key 17j or the DOWN key 17k in the above embodiments. Functions of the keys in the second mode may be set otherwise than the above. The second direction keys 17g need not necessarily be provided outside the first direction key 17f. The second direction keys 17g need not necessarily be arranged concentrically with the first direction key 17f and may be arranged apart from the first direction key 17f on the remote controller 17. The RIGHT key 17h, the LEFT key 17i, the UP key 17j and the DOWN key 17k may be integrated into one key and arranged apart from the first direction key 17f on the remote controller 17 or may be arranged on the operating unit 16. Alternatively, the RIGHT key 17h and the LEFT key 17i may be integrated into one key and the UP key 17j and the DOWN key 17k may be integrated into another key. These keys can be placed in any position on the remote controller 17 or the operating unit 16. The first direction key 17f and the second direction keys 17g are not necessarily required to point four directions of up, down, right and left and only required to allow the user to intuitively recognize indicated directions.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content display apparatus comprising:
a display unit including a tab display area configured to display tabs and a content display area configured to display content;
a content display controller configured to control the content display area of the display unit to display content corresponding to one tab of the tabs;
a direction indicator configured to indicate one of directions;
a display changer configured to change the content displayed in the content display area in accordance with a direction indicated by the direction indicator; and
a tab display controller configured to change a display form of the tab display area in accordance with the direction indicated by the direction indicator.

2. The content display apparatus according to claim 1, wherein the direction indicator includes:
a first direction key configured to scroll the content displayed in the content display area; and
second keys indicating different directions and being provided separately from the first direction key.

3. The content display apparatus according to claim 1, wherein the direction indicator includes:
a first direction key configured to scroll the content displayed in the content display area; and
second keys indicating different directions and being arranged around and concentrically with the first direction key.

4. The content display apparatus according to claim 1, wherein, when the direction indicator indicates right or left, the display changer changes the content displayed in the content display area in such a manner that the content display area displays content corresponding to a right or left tab of the one tab.

5. The content display apparatus according to claim 1, wherein the tab display controller causes the tab display area not to be displayed when the direction indicator indicates an up direction and wherein the tab display controller causes the tab display area to be displayed when the direction indicator indicates a down direction.

6. The content display apparatus according to claim 1, wherein the tab display controller changes a position at which the tab display area is displayed in accordance with the direction indicated by the direction indicator.

7. The content display apparatus according to claim 1, wherein the tab display controller controls a shape of the tab display area in such a manner that the tabs are displayed in the tab display area having a horizontally longer shape when the direction indicator indicates an up direction, and the tabs are displayed in the tab display area having a vertically longer shape when the direction indicator indicates a right direction.

8. The content display apparatus according to claim 1, wherein
the tab display area includes a first display area and a second display area, and
the tab display controller interchanges tabs displayed in the first display area and tabs displayed in the second display area in accordance with the direction indicated by the direction indicator.

9. The content display apparatus according to claim 1, wherein the display changer magnifies the content displayed in the content display area when the direction indicator indicates an up direction and reduces the content when the direction indicator indicates a down direction.

10. A content display method which is used for a content display apparatus including a display unit including a tab display area configured to display tabs and a content display area configured to display content, and a direction indicator configured to indicate one of directions, the method comprising:
controlling the content display area of the display unit to display content corresponding to one tab of the tabs;
changing the content displayed in the content display area in accordance with a direction indicated by the direction indicator; and
changing a display form of the tab display area in accordance with the direction indicated by the direction indicator.

11. The content display method according to claim 10, wherein the direction indicator includes:
a first direction key configured to scroll the content displayed in the content display area; and
second keys indicating different directions and being provided separately from the first direction key.

12. The content display method according to claim 10, wherein the direction indicator includes:
a first direction key configured to scroll the content displayed in the content display area; and
second keys indicating different directions and being arranged around and concentrically with the first direction key.

13. The content display method according to claim 10, wherein, when the direction indicator indicates right or left, the content displayed in the content display area is changed in such a manner that the content display area displays content corresponding to a right or left tab of the one tab.

14. The content display method according to claim 10, wherein the tab display area is caused not to be displayed when the direction indicator indicates an up direction and wherein the tab display area is caused to be displayed when the direction indicator indicates a down direction.

15. The content display method according to claim 10, wherein a position at which the tab display area is displayed is changed in accordance with the direction indicated by the direction indicator.

16. The content display method according to claim 10, wherein a shape of the tab display area is changed in such a manner that the tabs are displayed in the tab display area having a horizontally longer shape when the direction indicator indicates an up direction, and the tabs are displayed in the tab display area having a vertically longer shape when the direction indicator indicates a right direction.

17. The content display method according to claim 1, wherein
the tab display area includes a first display area and a second display area, and
tabs displayed in the first display area and tabs displayed in the second display area are interchanged in accordance with the direction indicated by the direction indicator.

18. The content display method according to claim 1, wherein the content displayed in the content display area is magnified when the direction indicator indicates an up direction and the content is reduced when the direction indicator indicates a down direction.
